(19) United States
(12) Patent Application Publication
(10) Pub. No.: US 2023/0255420 A1
(43) Pub. Date: Aug. 17, 2023

(54) MAINTENANCE ALERTS FOR AUTONOMOUS CLEANING ROBOTS

(71) Applicant: iRobot Corporation, Bedford, MA (US)

(72) Inventors: Michael Mullinax, Northborough, MA (US); John Luff, Andover, MA (US); Ledia Dilo, Northborough, MA (US)

(21) Appl. No.: 17/673,386

(22) Filed: Feb. 16, 2022

(51) Int. Cl. A47L 9/28; H04N 5/225; G06V 20/50

(52) U.S. Cl. CPC A47L 9/2805; A47L 9/2852; A47L 9/2873; A47L 9/2894; H04N 5/2256; H04N 5/2259; G06V 20/50; A47L 2201/02; A47L 2201/04; G02B 27/0081

(57) ABSTRACT

A robot cleaning system includes a mobile cleaning robot, a robot docking station, and a camera. The mobile cleaning robot includes a drive operable to move the mobile cleaning robot across a floor surface, a cleaning assembly configured to clean the floor surface, and a debris bin. The robot docking station includes a housing and a platform defined in the housing, the platform configured to receive the mobile cleaning robot in a docking position. The camera is configured to capture imagery of an underside of the mobile cleaning robot. In some implementations, the camera is disposed on or within the mobile cleaning robot. In some implementations, the camera is disposed in the platform of the robot docking station.

### TECHNICAL FIELD

This specification relates to the maintenance of autonomous cleaning robots.

### BACKGROUND

Autonomous cleaning robots are robots that can perform desired cleaning operations, such as vacuum cleaning, in environments without continuous human guidance. An autonomous cleaning robot can automatically dock with a docking station for various purposes including charging a battery of the autonomous cleaning robot and/or evacuating debris from a debris bin of the autonomous cleaning robot. The docking station can enable the robot to perform cleaning operations while requiring reduced levels of user maintenance. However, the autonomous cleaning robot may still benefit from periodic maintenance performed by a user. User maintenance of the autonomous cleaning robot may include cleaning a charging contact of the robot, removing objects wrapped around a component of the robot (e.g., a roller brush, a side brush, a wheel, etc.), replacing a damaged component of the robot, and removing debris that is obstructing an evacuation opening of the mobile cleaning robot.

### SUMMARY

In certain systems, an autonomous cleaning robot may automatically dock with a docking station to charge its battery and/or to evacuate debris from its debris bin. Systems that include a robot and a docking station (sometimes referred to as an “evacuation station”) can have advantages including increasing the convenience for a user of the system and saving the user time. For example, automatic charging and evacuation operations can reduce the frequency at which a user manually interacts with the robot (e.g., to charge the robot's battery, to empty the robot's debris bin, etc.). In some cases, a docking station can include its own debris canister having a volumetric capacity greater than that of the robot's debris bin. Therefore, the frequency at which the user empties the docking station's debris canister may be lower than the frequency at which the user would empty the robot's debris bin in the absence of a docking station. This can reduce the time spent by the user and the mess encountered by the user while operating the system.

Without detracting from the above-mentioned benefits of systems including an autonomous cleaning robot and a docking station (especially those with automated charging and/or evacuation operations), it may still be beneficial for a user to periodically perform manual maintenance on the robot. For example, periodic user maintenance of the robot can be beneficial for optimizing the performance and lifespan of the robot. It may be possible to detect conditions when user maintenance may be recommended or required (i.e., “maintenance conditions”), and in response to detecting such conditions, send an alert to the user. In some cases, maintenance conditions can be detected by identifying specific issues such as a dirty or damaged robot component, an object wrapped around a robot component, or debris obstructing the robot's evacuation port. Maintenance conditions can also be detected by tracking a number of docking events, number of evacuation operations, or amount of time since user maintenance was last performed.

In some cases, maintenance conditions may not be readily visible to the user, and sending an alert to the user about a detected maintenance condition can have the advantage of making the user aware of the maintenance condition when it may have otherwise gone unnoticed. For example, some maintenance conditions may be associated with a bottom portion of the robot (e.g., hair wrapped around a roller brush of the robot) and may not be noticeable by the user unless the user flips the robot upside down. If regular operation of the robot does not require the user to lift up the robot or to flip the robot upside down (e.g., to empty a debris bin of the robot), such maintenance conditions might go unnoticed for a substantial period of time. The technology described herein has the advantage of alerting the user to maintenance conditions at an earlier point in time, allowing the user to perform maintenance that can improve the cleaning performance of the robot and/or increase the robot's lifespan. For example, in some implementations described herein, a camera used to detect maintenance conditions can be disposed in a platform of the robot docking station and can be configured to capture imagery of an underside of the robot. This can have the advantage of detecting maintenance conditions that may otherwise go unnoticed by the user.

After being alerted about a maintenance condition, the user can perform maintenance on the autonomous cleaning robot to fix existing issues or to prevent future issues from arising. This can alert the user to maintenance conditions that the user may not otherwise have noticed and/or encourage the user to adhere to a recommended maintenance regime. This can improve the performance and overall lifespan of the autonomous cleaning robot as well as the docking station. This can be especially important for systems with which users may have infrequent manual interactions (e.g., once every 2 weeks, once every 3 weeks, once every month, once every two months, etc.). In some implementations, the alert sent to the user can include information including an image, a location of interest, and/or details about a type of the maintenance condition. In some implementations, the alert can be an audible alert. This can improve the user experience by removing ambiguity about the maintenance condition and the corresponding actions the user should take. This can also improve the user experience by reducing the burden on the user to preemptively check the autonomous cleaning robot and docking station for potential maintenance conditions.

The technology described herein can be integrated in the docking station, the robot, or both. For example, in some cases, a camera used to detect maintenance conditions can be disposed on the robot docking station (e.g., in a platform of the robot docking station). This can have the advantage of enabling detection of maintenance conditions simultaneously to performing charging and/or docking operations. It can also have the benefit of enabling frequent checks for maintenance conditions, such as anytime the robot docks with the docking station (e.g., after every cleaning operation). In some cases, a camera used to detect maintenance conditions can be disposed on or within the cleaning robot. This too can have the benefit of enabling frequent checks for maintenance conditions, such as anytime the robot docks with the docking station (e.g., after every cleaning operation). In addition, it can have the advantage of utilizing hardware such as cameras already installed on existing mobile cleaning robots, thereby reducing the cost of implementing the features described herein.

In a general aspect, a robot docking station is provided. The robot docking station includes a housing, a platform defined in the housing, and a camera disposed in the platform. The platform is configured to receive a mobile cleaning robot in a docking position, and the camera is configured to capture imagery of an underside of the mobile cleaning robot.

Implementations of the robot docking station can include one or more of the following features. The camera can capture the imagery of the underside of the mobile cleaning robot while the mobile cleaning robot is in the docking position. The camera can capture the imagery of the underside of the mobile cleaning robot while the mobile cleaning robot navigates onto the platform. The camera can capture a first image of the underside of the mobile cleaning robot while the robot is positioned at a first location on the platform. The first image can correspond to a first component on an undercarriage of the mobile cleaning robot. The camera can capture a second image of the underside of the mobile cleaning robot while the robot is positioned at a second location on the platform. The first image can correspond to a first component on an undercarriage of the mobile cleaning robot and the second image can correspond to a second component on the undercarriage of the mobile cleaning robot. The second location on the platform can be the docking position. A field of view of the camera can be sufficiently wide to capture imagery of a full width of the mobile cleaning robot. The camera can be an upward facing camera. The robot docking station can include one or more optical components configured to increase an effective field of view of the camera. The robot docking station can include at least one additional camera disposed in the platform, the at least one additional camera configured to capture additional imagery of the underside of the mobile cleaning robot. The robot docking station can include a light source configured to illuminate the underside of the mobile cleaning robot. The robot docking station can include an image analysis module configured to analyze the imagery captured by the camera to detect a maintenance condition. The maintenance condition can be indicative of debris disposed on a charging contact of the mobile cleaning robot, an object wrapped around a roller brush of the mobile cleaning robot, a damaged roller brush of the mobile cleaning robot, a damaged side brush of the mobile cleaning robot, an object wrapped around a side brush of the mobile cleaning robot, an object wrapped around a wheel of the mobile cleaning robot, and/or debris obstructing an evacuation opening of the mobile cleaning robot. The robot docking station can include a communication module configured to transmit data to a remote computing device. The transmitted data can include data representative of the imagery captured by the camera and/or data representative of a maintenance alert. The maintenance alert can correspond to a maintenance condition that is detectable via analyzing the imagery captured by the camera, an occurrence of a predetermined number of docking events, an occurrence of a predetermined number of evacuation operations, and/or an end-of-life of a battery of the mobile cleaning robot. The communication module can be configured to receive, from the remote computing device, data representative of an acknowledgement that a user has viewed the underside of the mobile cleaning robot. The communication module can be configured to transmit a signal to the mobile cleaning robot to prevent the mobile cleaning robot from executing a cleaning operation until the data representative of the acknowledgement is received.

In another general aspect, a robot cleaning system is provided. The robot cleaning system includes a mobile cleaning robot, a robot docking station, and a camera. The mobile cleaning robot includes a drive operable to move the mobile cleaning robot across a floor surface, a cleaning assembly configured to clean the floor surface, and a debris bin. The robot docking station includes a housing and a platform defined in the housing. The platform is configured to receive the mobile cleaning robot in a docking position. The camera is configured to capture imagery of an underside of the mobile cleaning robot.

Implementations of the robot cleaning system can include one or more of the following features. The camera can be disposed on or within the mobile cleaning robot. The robot docking station can include one or more optical components configured to adjust a field of view of the camera to include the underside of the mobile cleaning robot. The camera can be disposed in the platform of the robot docking station. The camera can capture the imagery of the underside of the mobile cleaning robot while the mobile cleaning robot is in the docking position. The camera can capture a first image of the underside of the mobile cleaning robot while the robot is positioned at a first location on the platform. The first image can correspond to a first component on an undercarriage of the mobile cleaning robot. The camera can capture a second image of the underside of the mobile cleaning robot while the robot is positioned at a second location on the platform. The first image can correspond to a first component on an undercarriage of the mobile cleaning robot and the second image can correspond to a second component on the undercarriage of the mobile cleaning robot. The second location on the platform can be the docking position. A field of view of the camera can be sufficiently wide to capture imagery of a full width of the mobile cleaning robot. The camera can be an upward facing camera. The robot docking station can include one or more optical components configured to increase an effective field of view of the camera. The robot docking station can include at least one additional camera disposed in the platform, the at least one additional camera configured to capture additional imagery of the underside of the mobile cleaning robot. The robot docking station can include a light source configured to illuminate the underside of the mobile cleaning robot. The robot docking station can include an image analysis module configured to analyze the imagery captured by the camera to detect a maintenance condition. The maintenance condition can be indicative of debris disposed on a charging contact of the mobile cleaning robot, an object wrapped around a roller brush of the mobile cleaning robot, a damaged roller brush of the mobile cleaning robot, a damaged side brush of the mobile cleaning robot, an object wrapped around a side brush of the mobile cleaning robot, an object wrapped around a wheel of the mobile cleaning robot, and/or debris obstructing an evacuation opening of the mobile cleaning robot. The robot docking station can include a communication module configured to transmit data to a remote computing device. The transmitted data can include data representative of the imagery captured by the camera and/or data representative of a maintenance alert. The maintenance alert can correspond to a maintenance condition that is detectable via analyzing the imagery captured by the camera, an occurrence of a predetermined number of docking events, an occurrence of a predetermined number of evacuation operations, and/or an end-of-life of a battery of the mobile cleaning robot. The communication module can be configured to receive, from the remote computing device, data representative of an acknowledgement that a user has viewed the underside of the mobile cleaning robot. The mobile cleaning robot can be configured not to execute a cleaning operation until the data representative of the acknowledgement is received.

In another general aspect, a method performed by a robot docking station is provided. The method includes capturing imagery of an underside of a mobile cleaning robot and analyzing the captured imagery to detect a maintenance condition.

Implementations of the method can include one or more of the following features. Capturing the imagery of the underside of the mobile cleaning robot can include capturing the imagery while the mobile cleaning robot is in a docking position. Capturing the imagery of the underside of the mobile cleaning robot can include capturing the imagery while the mobile cleaning robot navigates onto a platform of the robot docking station. Capturing the imagery of the underside of the mobile cleaning robot can include capturing a first image of the underside of the mobile cleaning robot while the robot is positioned at a first location on a platform of the robot docking station. The first image can correspond to a first component on an undercarriage of the mobile cleaning robot. Capturing the imagery of the underside of the mobile cleaning robot can include capturing a second image of the underside of the mobile cleaning robot while the robot is positioned at a second location on a platform of the robot docking station. The first image can correspond to a first component on an undercarriage of the mobile cleaning robot and the second image can correspond to a second component on the undercarriage of the mobile cleaning robot. The second location on the platform can be a docking position. Capturing the imagery of the underside of the mobile cleaning robot can include capturing the imagery with a camera disposed on or within the mobile cleaning robot. Capturing the imagery of the underside of the mobile cleaning robot can include capturing the imagery with a camera disposed in a platform of the robot docking station. The method can include illuminating the underside of the mobile cleaning robot with a light source. Analyzing the captured imagery to detect the maintenance condition can include analyzing the imagery to detect debris disposed on a charging contact of the mobile cleaning robot, an object wrapped around a roller brush of the mobile cleaning robot, a damaged roller brush of the mobile cleaning robot, a damaged side brush of the mobile cleaning robot, an object wrapped around a side brush of the mobile cleaning robot, an object wrapped around a wheel of the mobile cleaning robot, and/or debris obstructing an evacuation opening of the mobile cleaning robot. The method can include transmitting data to a remote computing device. Transmitting data to the remote computing device can include transmitting data representative of the captured imagery. Transmitting data to the remote computing device can include transmitting data representative of a maintenance alert corresponding to a detected maintenance condition. The method can include presenting an indication of a detected maintenance condition on a display of the robot docking station. The method can include receiving an acknowledgement from a user that the user has viewed the underside of the mobile cleaning robot. The method can include, responsive to detecting a maintenance condition, halting evacuation operations until receiving an acknowledgement from a user that the user has viewed the underside of the mobile cleaning robot. The method can include receiving an indication from a user that maintenance of the mobile cleaning robot has been performed. The method can include, responsive to detecting a maintenance condition, halting evacuation operations until receiving an indication from a user that maintenance of the mobile cleaning robot has been performed.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIG. 1 is a perspective view of a system including an autonomous mobile cleaning robot and a robot docking station.

FIG. 2A is a perspective view of a mobile cleaning robot.

FIG. 2B is a bottom view of a mobile cleaning robot.

FIG. 2C is a cross-sectional side view of a portion of a mobile cleaning robot including a cleaning head assembly and a cleaning bin.

FIG. 3A is an isometric view of a portion of a robot docking station.

FIG. 3B is an isometric view of a robot docking station.

FIG. 4 is a bottom view of a mobile cleaning robot including maintenance conditions.

FIG. 5 is a side view of a system including a mobile cleaning robot and a robot docking station.

FIGS. 6A-6F are diagrams illustrating exemplary user interface displays presented on a mobile computing device.

FIG. 7 is a flowchart of a process for alerting a user to perform maintenance on a mobile cleaning robot.

FIG. 8 is a flowchart of a process for detecting a maintenance condition of a mobile cleaning robot.

FIG. 9 is a flowchart of a process for notifying a user of a maintenance condition of a mobile cleaning robot.

FIG. 10 shows an example of a computing device and a mobile computing device.

Like reference numbers and designations in the various drawings indicate like elements.

### DETAILED DESCRIPTION

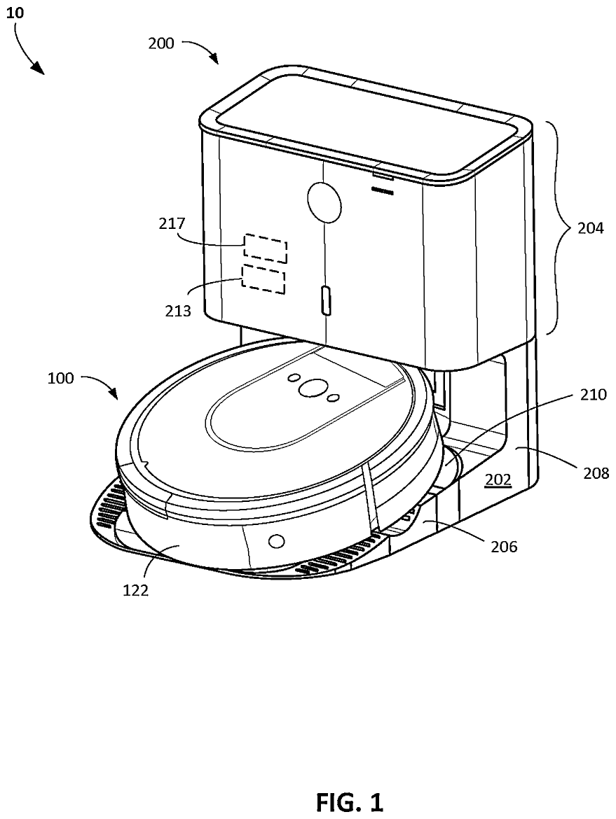

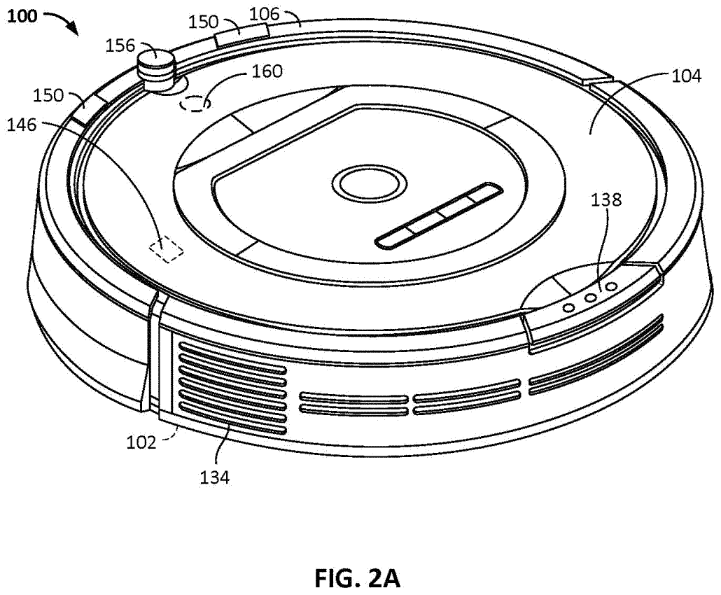

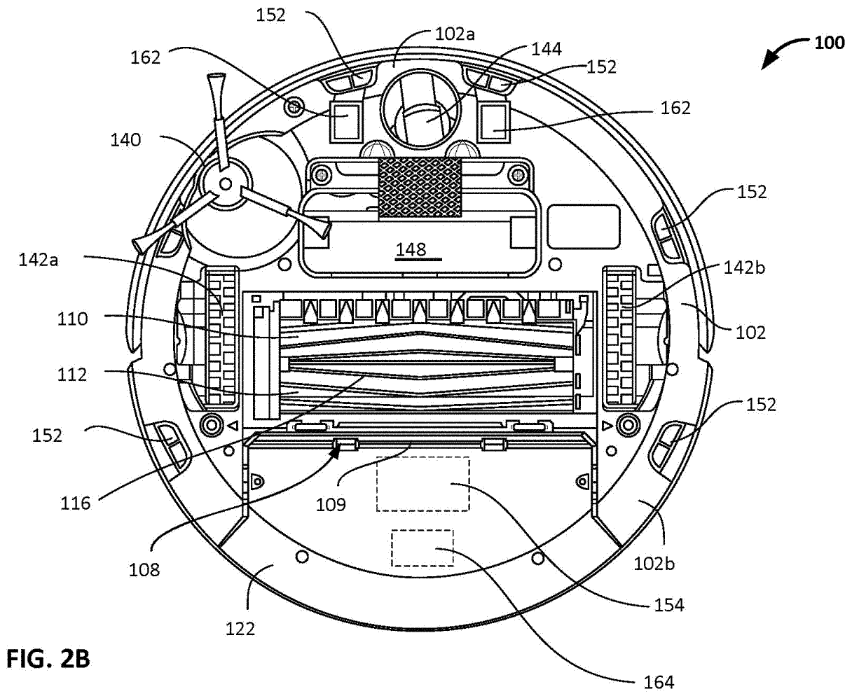

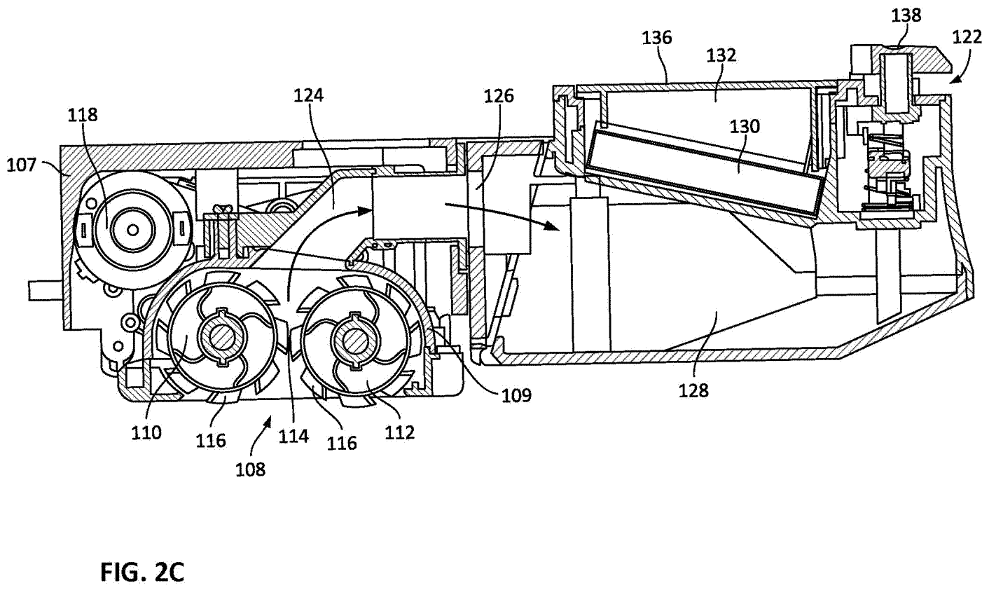

FIG. 1 illustrates a robotic floor cleaning system 10 featuring a mobile floor cleaning robot 100 and a docking station 200. In some implementations, the robot 100 is designed to autonomously traverse and clean a floor surface by collecting debris from the floor surface in a cleaning bin 122 (also referred to as a “debris bin”). The docking station 200 is statically positioned on the floor surface while the robot 100 autonomously moves about the floor surface. In some implementations, when the robot 100 completes a cleaning operation (or a portion of a cleaning operation) or determines that its battery (e.g., battery 148 shown in FIG. 2B) is running low on charge, the robot 100 may navigate to the docking station 200 to charge its battery. In some implementations, when the robot 100 completes a cleaning operation (or a portion of a cleaning operation) or detects that the cleaning bin 122 is full, it may navigate to the docking station 200 to have the cleaning bin 122 emptied. If the docking station 200 is capable of emptying the cleaning bin 122 of the robot 100, for example, by evacuating the debris from the cleaning bin 122, the docking station 200 can also be referred to as an “evacuation station.” Evacuating debris from the robot's cleaning bin 122 enables the robot 100 to perform another cleaning operation or to continue a cleaning operation to collect more debris from the floor surface.

The docking station 200 includes a housing 202 and a debris canister 204 (sometimes referred to as a “debris bin” or “receptacle”). The housing 202 of the docking station 200 can include one or more interconnected structures that support various components of the docking station 200. These various components include an air mover 217 (depicted schematically), a system of airflow paths for airflow generated by the air mover 217, and a controller 213 (depicted schematically). The housing 202 defines a platform 206 and a base 208 that supports the debris canister 204. In some implementations, the canister 204 is removable from the base 208, while in other implementations, the canister 204 is integral with the base 208. As shown in FIG. 1, the robot 100 can dock with the docking station 200 by advancing onto the platform 206 and into a docking bay 210 of the base 208. Once the docking bay 210 receives the robot 100, the air mover 217 (sometimes referred to as an “evacuation vacuum”) carried within the base 208 draws debris from the cleaning bin 122 of the robot 100, through the housing 202, and into the debris canister 204. The air mover 117 can include a fan and a motor for drawing air through the docking station 200 and the docked robot 100 (and out through an exhaust) during an evacuation cycle.

FIGS. 2A-2C illustrate an example mobile floor cleaning robot 100 that may be employed in the cleaning system 10 shown in FIG. 1. In this example, the robot 100 includes a main chassis 102 which carries an outer shell 104. The outer shell 104 of the robot 100 couples a movable bumper 106 to the chassis 102. The robot 100 may move in forward and reverse drive directions; consequently, the chassis 102 has corresponding forward and back ends, 102a and 102b respectively. The forward end 102a at which the bumper 106 is mounted faces the forward drive direction. In some implementations, the robot 100 may navigate in the reverse direction with the back end 102b oriented in the direction of movement, for example during escape behaviors, bounce behaviors, and obstacle avoidance behaviors in which the robot 100 drives in reverse.

A cleaning head assembly 108 is located in a roller housing 109 coupled to a middle portion of the chassis 102. As shown in FIG. 2C, the cleaning head assembly 108 is mounted in a cleaning head frame 107 attachable to the chassis 102. The cleaning head frame 107 supports the roller housing 109. The cleaning head assembly 108 includes a front roller 110 and a rear roller 112 rotatably mounted to the roller housing 109, parallel to the floor surface, and spaced apart from one another by a small elongated gap 114. The front 110 and rear 112 rollers are designed to contact and agitate the floor surface during use. Thus, in this example, each of the rollers 110, 112 features a pattern of chevron-shaped vanes 116 distributed along its cylindrical exterior. Other suitable configurations, however, are also contemplated. For example, in some implementations, at least one of the front and rear rollers may include bristles and/or elongated pliable flaps for agitating the floor surface.

Each of the front 110 and rear 112 rollers is rotatably driven by a brush motor 118 to dynamically lift (or “extract”) agitated debris from the floor surface. A robot vacuum (not shown) disposed in a cleaning bin 122 towards the back end 102b of the chassis 102 includes a motor-driven fan that pulls air up through the gap between the rollers 110, 112 to provide a suction force that assists the rollers in extracting debris from the floor surface. Air and debris that passes through the gap 114 are routed through a plenum 124 that leads to an opening 126 of the cleaning bin 122. The opening 126 leads to a debris collection cavity 128 of the cleaning bin 122. A filter 130 located above the cavity 128 screens the debris from an air passage 132 leading to the air intake (not shown) of the robot vacuum.

Filtered air exhausted from the robot vacuum is directed through an exhaust port 134 (see FIG. 2A). In some examples, the exhaust port 134 includes a series of parallel slats angled upward, so as to direct airflow away from the floor surface. This design prevents exhaust air from blowing dust and other debris along the floor surface as the robot 100 executes a cleaning routine. The filter 130 is removable through a filter door 136. The cleaning bin 122 is removable from the shell 104 by a spring-loaded release mechanism 138.

Installed along the sidewall of the chassis 102, proximate the forward end 102a and ahead of the rollers 110, 112 in a forward drive direction, is a side brush 140 rotatable about an axis perpendicular to the floor surface. The side brush 140 can include multiple arms extending from a central hub of the side brush 140, with each arm including bristles at its distal end. The side brush 140 allows the robot 100 to produce a wider coverage area for cleaning along the floor surface. In particular, the side brush 140 may flick debris from outside the area footprint of the robot 100 into the path of the centrally located cleaning head assembly.

Installed along either side of the chassis 102, bracketing a longitudinal axis of the roller housing 109, are independent drive wheels 142a, 142b that mobilize the robot 100 and provide two points of contact with the floor surface. The forward end 102a of the chassis 102 includes a non-driven, multi-directional caster wheel 144 which provides additional support for the robot 100 as a third point of contact with the floor surface.

A robot controller circuit 146 (depicted schematically) is carried by the chassis 102. The robot controller circuit 146 is configured (e.g., appropriately designed and programmed) to govern over various other components of the robot 100 (e.g., the rollers 110, 112, the side brush 140, and/or the drive wheels 142a, 142b). As one example, the robot controller circuit 146 may provide commands to operate the drive wheels 142a, 142b in unison to maneuver the robot 100 forward or backward. As another example, the robot controller circuit 146 may issue a command to operate drive wheel 142a in a forward direction and drive wheel 142b in a rearward direction to execute a clock-wise turn. Similarly, the robot controller circuit 146 may provide commands to initiate or cease operation of the rotating rollers 110, 112 or the side brush 140. For example, the robot controller circuit 146 may issue a command to deactivate or reverse bias the rollers 110, 112 if they become tangled. In some implementations, the robot controller circuit 146 is designed to implement a suitable behavior-based-robotics scheme to issue commands that cause the robot 100 to navigate and clean a floor surface in an autonomous fashion. The robot controller circuit 146, as well as other components of the robot 100, may be powered by a battery 148 disposed on the chassis 102 forward of the cleaning head assembly 108.

The robot controller circuit 146 implements the behavior-based-robotics scheme based on feedback received from a plurality of sensors distributed about the robot 100 and communicatively coupled to the robot controller circuit 146. For instance, in this example, an array of proximity sensors 150 (depicted schematically) are installed along the periphery of the robot 100, including the front end bumper 106. The proximity sensors 150 are responsive to the presence of potential obstacles that may appear in front of or beside the robot 100 as the robot 100 moves in the forward drive direction. The robot 100 further includes an array of cliff sensors 152 installed along the forward end 102a of the chassis 102. The cliff sensors 152 are designed to detect a potential cliff, or flooring drop, forward of the robot 100 as the robot 100 moves in the forward drive direction. More specifically, the cliff sensors 152 are responsive to sudden changes in floor characteristics indicative of an edge or cliff of the floor surface (e.g., an edge of a stair). The robot 100 still further includes a bin detection system 154 (depicted schematically) for sensing an amount of debris present in the cleaning bin 122. As described in U.S. Patent Publication 2012/0291809 (the entirety of which is hereby incorporated by reference), the bin detection system 154 is configured to provide a bin-full signal to the robot controller circuit 146. In some implementations, the bin detection system 154 includes a debris sensor (e.g., a debris sensor featuring at least one emitter and at least one detector) coupled to a microcontroller. The microcontroller can be configured (e.g., programmed) to determine the amount of debris in the cleaning bin 122 based on feedback from the debris sensor. In some examples, if the microcontroller determines that the cleaning bin 122 is nearly full (e.g., ninety or one-hundred percent full), the bin-full signal transmits from the microcontroller to the robot controller circuit 146. Upon receipt of the bin-full signal, the robot 100 navigates to the docking station 200 to empty debris from the cleaning bin 122. In some implementations, the robot 100 maps an operating environment during a cleaning run, keeping track of traversed areas and untraversed areas and stores a pose on the map at which the controller circuit 146 instructed the robot 100 to return to the docking station 200 for emptying. Once the cleaning bin 122 is evacuated, the robot 100 returns to the stored pose at which the cleaning routine was interrupted and resumes cleaning if the mission was not already complete prior to evacuation.

In some implementations, the robot 100 includes at least one vision-based sensor, such as an image capture device 160 (depicted schematically) having a field of view optical axis oriented in the forward drive direction of the robot, for detecting features and landmarks in the operating environment and building a map using VSLAM technology. The image capture device 160 can be, for example, a camera or an optical sensor. The image capture device 160 is configured to capture imagery of the environment. In particular, the image capture device 160 is positioned on a forward portion of the robot 100 and has a field of view covering at least a portion of the environment ahead of the robot 100. In some implementations, the field of view of the image capture device 160 can extend both laterally and vertically. For example, a center of the field of view can be 5 to 45 degrees above the horizon or above the floor surface, e.g., between 10 and 30 degrees, 10 and 40 degrees, 15 and 35 degrees, or 20 and 30 degrees above the horizon or above the floor surface. A horizontal angle of view of the field of view can be between 90 and 150 degrees, e.g., between 100 and 140 degrees, 110 and 130 degrees, or 115 and 125 degrees. A vertical angle of view of the field of view can be between 60 and 120 degrees, e.g., between 70 and 110 degrees, 80 and 100 degrees, 85 and 95 degrees. In some implementations, the image capture device 160 can capture imagery of a portion of the floor surface forward of the robot 100 or imagery of an object on the portion of the floor surface (e.g., a rug). The imagery can be used by the robot 100 for navigating about the environment and can, in particular, be used by the robot 100 to navigate relative to the objects on the floor surface to avoid error conditions.

Various other types of sensors, though not shown in the illustrated examples, may also be incorporated with the robot 100 without departing from the scope of the present disclosure. For example, a tactile sensor responsive to a collision of the bumper 106 and/or a brush-motor sensor responsive to motor current of the brush motor 118 may be incorporated in the robot 100.

A communications module 156 is mounted on the shell 104 of the robot 100. The communications module 156 is operable to receive signals projected from an emitter of the docking station 200 and (optionally) an emitter of a navigation or virtual wall beacon. In some implementations, the communications module 156 may include a conventional infrared (“IR”) or optical detector including an omni-directional lens. However, any suitable arrangement of detector(s) and (optionally) emitter(s) can be used as long as the emitter of the docking station 200 is adapted to match the detector of the communications module 156. The communications module 156 is communicatively coupled to the robot controller circuit 146. Thus, in some implementations, the robot controller circuit 146 may cause the robot 100 to navigate to and dock with the evacuation station 200 in response to the communications module 156 receiving a homing signal emitted by the docking station 200. Docking, confinement, home base, and homing technologies are discussed in U.S. Pat. Nos. 7,196,487; 7,188,000, U.S. Patent Application Publication No. 20050156562, and U.S. Patent Application Publication No. 20140100693 (the entireties of which are hereby incorporated by reference).

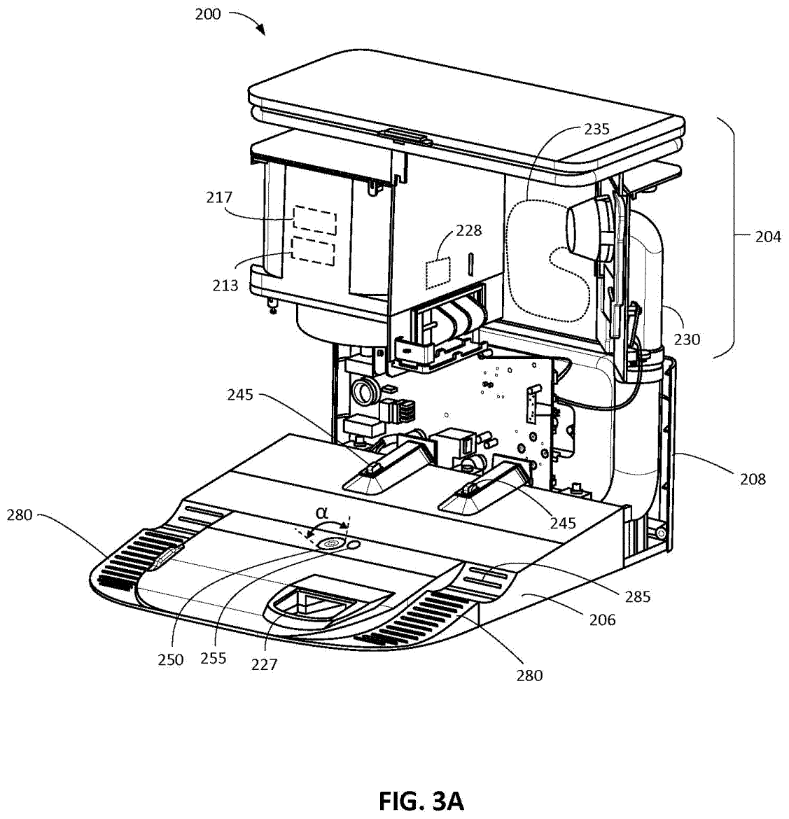

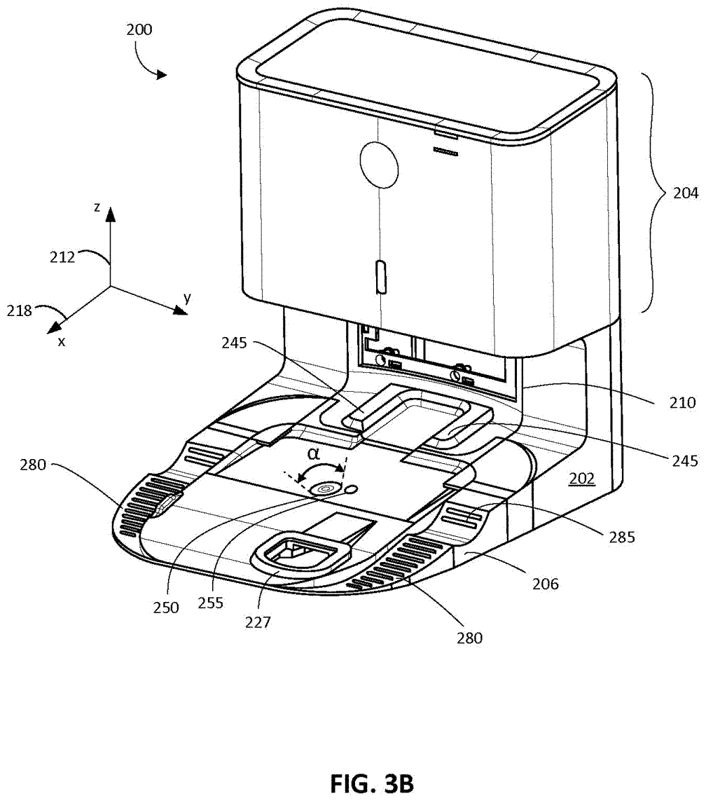

Electrical contacts 162 are installed along a front portion of the underside of the robot 100. The electrical contacts 162 are configured to mate with corresponding electrical contacts 245 of the docking station 200 (shown in FIGS. 3A and 3B) when the robot 100 is properly docked at the docking station 200. The mating between the electrical contacts 162 and the electrical contacts 245 enables communication between the controller 213 of the docking station 200 (shown in FIG. 1) and the robot controller circuit 146. The docking station 200 can initiate an evacuation operation and/or a charging operation based on those communications. In other examples, the communication between the robot 100 and the docking station 200 is provided over an infrared (IR) communication link. In some examples, the electrical contacts 162 on the robot 100 are located on a back side of the robot 100 rather than an underside of the robot 100 and the corresponding electrical contacts 245 on the docking station 200 are positioned accordingly.

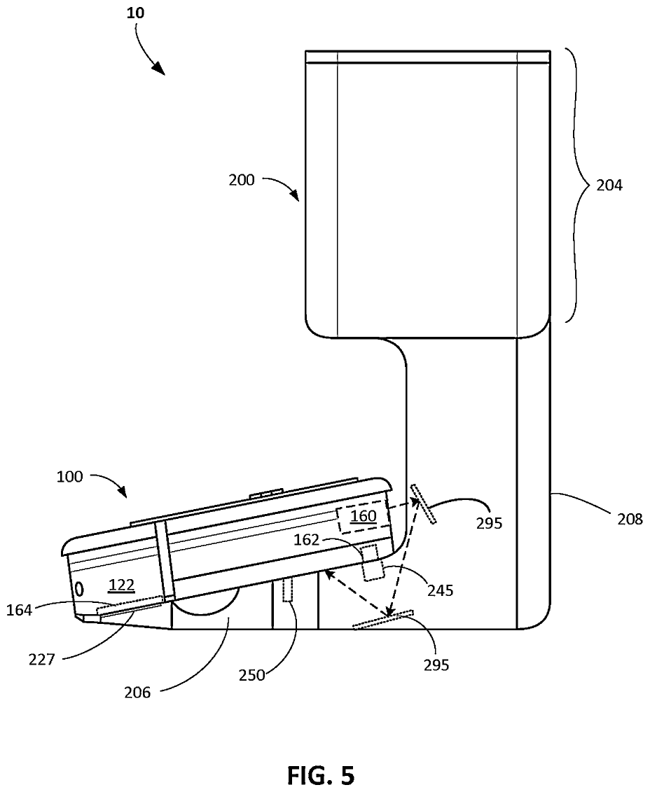

An evacuation port 164 is included in the robot 100 and provides access to the cleaning bin 122 during evacuation operations. For example, when the robot 100 is properly docked at the docking station 200, the evacuation port 164 is aligned with an intake port 227 of the docking station 200 (see FIG. 5). Alignment between the evacuation port 164 and the intake port 227 provides for continuity of a flow path along which debris can travel out of the cleaning bin 122 and into the canister 204 of the docking station 200. As described above with respect to FIG. 1, during evacuation operations, debris is suctioned by the docking station 200 from the cleaning bin 122 of the robot 100 into the canister 204, where it is stored until it is removed by a user. In some implementations, the gap 114 between the rollers 110, 112 can be aligned with the intake port 227 when the robot 100 is docked at the docking station 200. In such implementations, the gap 114 can serve the same functionality as the evacuation port 164 without the need for a dedicated evacuation port.

Docking station technologies are discussed in U.S. Pat. No. 9,462,920 (the entirety of which is hereby incorporated by reference). FIGS. 3A and 3B illustrate an example docking station 200 that may be employed in the cleaning system 10 shown in FIG. 1. In FIG. 3A, the docking station 200 is illustrated with a front panel of the base 208 removed and an outer wall of the canister 204 removed. The docking station 200 includes a platform 206 to receive a mobile robot (e.g., the robot 100) to enable the mobile robot to dock at the docking station 200 (e.g., when the robot detects that its debris bin is full, when the robot detects that it needs charging, etc.). To assist with proper alignment and positioning of the robot 100 while docking, the platform 206 can include features such as wheel ramps 280 (shown in FIG. 3B) that are sized and shaped appropriately to receive the drive wheels 142a, 142b of the robot 100. The wheel ramps 280 can include traction features 285 that can increase traction between the mobile robot 100 and the inclined platform 206 so that the robot 100 can navigate up the platform 206 and dock at the docking station 200.

The docking station 200 includes electrical contacts 245 disposed on the platform 206. The electrical contacts 245 are configured to mate with corresponding electrical contacts 162 of the mobile robot 100 (shown in FIG. 2B) when the robot 100 is properly docked at the docking station 200 (see FIG. 5). As described in relation to FIG. 2B, the mating between the electrical contacts 245 and the electrical contacts 162 enables communication between the controller 213 of the docking station 200 and the robot controller circuit 146. The docking station 200 can initiate an evacuation operation and/or a charging operation based on those communications.

The docking station 200 also includes an intake port 227 disposed on the platform 206. As described in relation to FIG. 2B, the intake port 227 is positioned to be aligned with the evacuation port 164 of the mobile robot 100 when the robot 100 is properly docked at the docking station 200 (see FIG. 5). Alignment between the evacuation port 164 and the intake port 227 provides for continuity of a flow path 230 along which debris can travel out of the cleaning bin 122 and into the canister 204 of the docking station 200. In some implementations, an air-permeable bag 235 (shown schematically) can be installed in the canister 204 to collect and store the debris that is transferred to the canister 204 via operation of the air mover 217.

In some implementations, the docking station 200 can include a pressure sensor 228 (shown schematically), which monitors the air pressure within the canister 204. The pressure sensor 228 can include a Micro-Electro-Mechanical System (MEMS) pressure sensor or any other appropriate type of pressure sensor. A MEMS pressure sensor is used in this implementation because of its ability to continue to accurately operate in the presence of vibrations due to, for example, mechanical motion of the air mover 217 or motion from the environment transferred to the docking station 200. The pressure sensor 228 can detect changes in air pressure in the canister 204 caused by the activation of the air mover 217 to remove air from the canister 204. The length of time for which evacuation is performed may be based on the pressure measured by the pressure sensor 228.

In some implementations, the docking station 200 can include an image capture device 250. The image capture device 250 can be a camera, optical sensor, or other vision-based sensor. As described herein, the image capture device 250 is configured to capture imagery of the robot 100 as the robot 100 approaches the docking station 200 or while the robot 100 is docked at the docking station 200. The captured imagery can be used, for example, to detect one or more conditions of the robot 100 as described in further detail herein.

In some implementations, the image capture device 250 can be disposed on or within the platform 206 and can have a field of view oriented in an upward direction (e.g., in the z-direction 212), for capturing imagery of one or more components of the robot 100 disposed on an undercarriage of the robot 100. In some implementations, the field of view of the image captured device 250 can extend both in the z-direction 212 and in an x-direction 218. For example, a center of the field of view can be 45 to 135 degrees above the horizon or above the floor surface, e.g., between 50 and 70 degrees, 70 and 80 degrees, 80 and 90 degrees, 90 and 100 degrees, or 100 and 120 degrees above the horizon or above the floor surface (with 90 degrees being directly upward-facing). An angle of view (a) of the field of view can be between 90 and 170 degrees, e.g., between 100 and 140 degrees, 110 and 130 degrees, 115 and 125, or 135 and 165 degrees. In some implementations, a horizontal angle of view of the image capture device 250 may differ from the vertical angle of view of the image capture device 250, but with both the horizontal angle of view and the vertical angle of view being between 90 and 170 degrees. In general, the angle of view (a) of the image capture device 250 can be selected such that it is wide enough to capture imagery of a full width of the robot 100 while the robot 100 approaches the docking station 200 or while the robot 100 is docked at the docking station.

In some implementations, the image capture device 250 may be movable (e.g., rotatable or translatable within the platform 206), potentially enabling the image capture device 250 to capture imagery along a full width of the robot 100 while having a smaller angle of view (a). In some implementations, the image capture device 250 might not be movable, but is configured to capture multiple images (e.g., video) of the robot 100 as the robot 100 moves relative to the image capture device 250 (e.g., while driving onto the platform 206 and while docking at the docking station 200). In some implementations, the docking station 200 can also include optical components such as mirrors or lenses, which can alter the field of view of the image capture device 250, potentially enabling the image capture device 250 to capture imagery along a full width of the robot 100 while having a smaller angle of view (a). In some implementations, the docking station 200 can include multiple image capture devices. In some implementations, rather than capturing imagery of a full width of the robot 100, the image capture device 250 can be configured to capture imagery of particular components (e.g., the side brush 140, the electrical contacts 162, the evacuation port 164, etc.) of the robot 100, enabling the image capture device to have an even smaller angle of view (a).

The docking station 200 can also include a light source 255 that can illuminate the underside of the robot 100 to improve the quality of the imagery captured by the image capture device 250. In some implementations, to conserve energy, the light source 255 is not always turned on, but only turns on to illuminate the underside of the robot 100 when the robot 100 is on the platform 206 or when the image capture device 250 is preparing to capture imagery.

Over the course of a lifespan of a mobile cleaning robot (e.g., the robot 100), various conditions may arise for which user maintenance of the robot may be recommended or required. Such conditions will be referred to herein as “maintenance conditions.” User interaction with the robot 100 to address maintenance conditions can improve the performance or increase the lifespan of the robot 100. Some maintenance conditions can be visually detectable while other maintenance conditions can be detected by other means (e.g., using air flow sensors, robot performance metrics, etc.). Some maintenance conditions can correspond to specific issues identified with respect to particular components of the robot 100, while other maintenance conditions can simply recommend general user maintenance to encourage a user to adhere to a recommended maintenance schedule. Various maintenance conditions are described herein. However, this discussion is not intended to be limiting, and those of ordinary skill in the art will recognize that other maintenance conditions may arise.

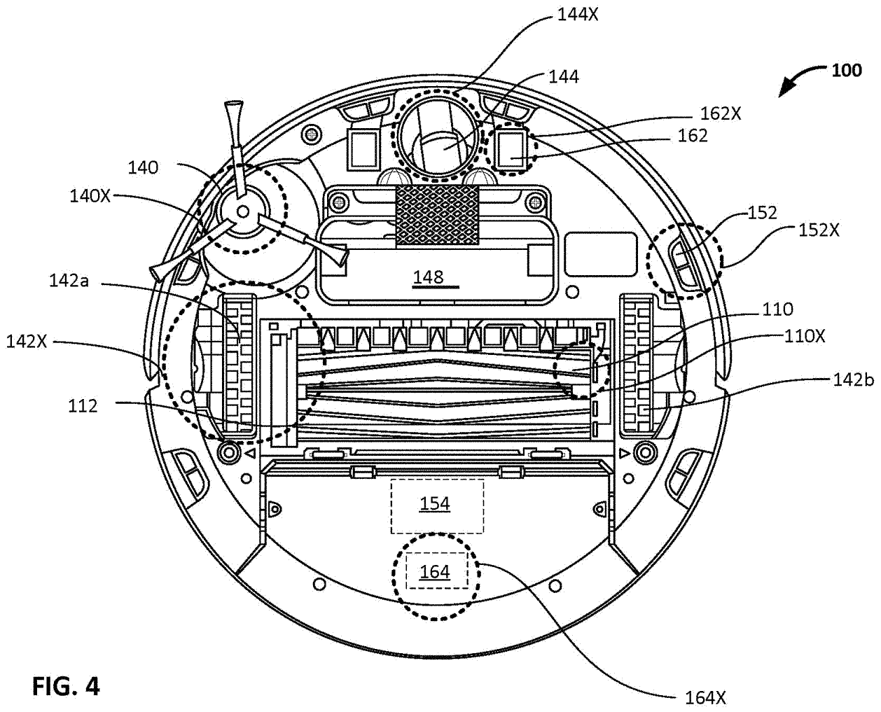

Referring to FIG. 4, a first maintenance condition 144X can correspond to a condition affecting the caster wheel 144. In some implementations, the maintenance condition 144X can correspond to the presence of hair (e.g., human hair, pet hair, etc.) or another object tangled around the caster wheel 144. In some implementations, the maintenance condition 144X can correspond to damage incurred by the caster wheel 144. The maintenance condition 144X can be visually detectable, for example, by visually identifying a foreign object wrapped around the caster wheel 144 or by visually identifying signs of damage to the caster wheel 144. In the presence of the maintenance condition 144X, it may be recommended that the user of the robot 100 dislodge any objects tangled around the caster wheel 144 and/or replace the caster wheel 144.

A second maintenance condition 162X can correspond to a condition affecting one of the electrical contacts 162. In some implementations, the maintenance condition 162X can correspond to the presence of a substantial amount of dust or debris on the electrical contact 162, which can interfere with the communication between the robot 100 and the docking station 200 and/or negatively impact charging of the battery 148. The maintenance condition 162X can be visually detectable, for example, by visually identifying the dust or debris on the electrical contact 162. The maintenance condition can also be detectable, for example, by detecting abnormal behavior with respect to the electrical contacts 162 such as an absence of communication between the robot 100 and the docking station 200 despite the robot 100 being docked at the docking station 200. In the presence of the maintenance condition 162X, it may be recommended that the user of the robot 100 clean the electrical contact 162.

A third maintenance condition 152X can correspond to a condition affecting one of the cliff sensors 152. In some implementations, the maintenance condition 152X can correspond to the presence of a substantial amount of dust or debris on the cliff sensor 152, which can negatively impact the performance of the cliff sensor 152. The maintenance condition 152X can be visually detectable, for example, by visually identifying the dust or debris on the cliff sensor 152. The maintenance condition can also be detectable, for example, by detecting abnormal behavior with respect to the cliff sensor 152 such as frequent false positive detection of potential cliffs. In the presence of the maintenance condition 152X, it may be recommended that the user of the robot 100 clean the cliff sensor 152.

A fourth maintenance condition 110X can correspond to a condition affecting the front roller 110. For illustrative purposes, the maintenance condition 110X is depicted in FIG. 4 as affecting only the front roller 110. However, it could additionally or alternatively affect the back roller 112. In some implementations, the maintenance condition 110X can correspond to presence of hair (e.g., human hair, pet hair, etc.) or another object tangled around the front roller 110. In some implementations, the maintenance condition 110X can correspond to damage incurred by the front roller 110 such as a tear in the material comprising the front roller 110 or a wearing down of the vanes 116. The maintenance condition 110X can be visually detectable, for example, by visually identifying a foreign object wrapped around the front roller 110 or by visually identifying signs of damage to the front roller 110. The maintenance condition can also be detectable, for example, by detecting abnormal behavior with respect to the roller 110 such as an abnormally high current draw when rotating the roller 110. In the presence of the maintenance condition 110X, it may be recommended that the user of the robot 100 dislodge any objects tangled around the front roller 110 and/or replace the front roller 110 (or the entire cleaning head assembly 108). In some implementations, due to the geometry of the roller 110, foreign objects such as hair may tend to become tangled around the distal ends of the front roller 110. Thus, it may be advantageous to focus the visual detection of the maintenance condition 110X at the distal ends of the roller 110. In other implementations, the maintenance condition 110X can be visually detected along the entire length of the roller 110. Depending on the orientation of the roller 110, signs of damage to the roller 110 and/or foreign objects trapped in the cleaning head assembly 108 may not always be immediately visible from the underside of the robot 100. Thus, in some examples, the rollers 110, 112 of the robot 100 can be rotated (e.g., by idling the brush motor 118) to assist with visually detecting the maintenance condition 110X.

A fifth maintenance condition 164X can correspond to a condition affecting the evacuation port 164. In some implementations, the maintenance condition 164X can correspond to the presence of a blockage (e.g., by dust or debris) of the evacuation port 164 or damage incurred by the evacuation port 164, which can negatively impact the efficacy of evacuation operations. In some implementations, the maintenance condition 164X can correspond to a condition in which a door (or other access mechanism) associated with the evacuation port 164 is damaged or is unable to close (e.g., due to the build-up of debris). The maintenance condition 164X can be visually detectable, for example, by visually identifying the blockage of the evacuation port 164 or by identifying that an access mechanism associated with the evacuation port 164 is damaged and/or will not close. The maintenance condition can also be detectable, for example, by detecting abnormalities during an evacuation operation such as unexpected air flow rates or air pressure values (e.g., as measured by air pressure sensor 228 shown in FIG. 3A). The maintenance condition 164X can also be detectable, for example, by detecting an absence of change in the levels of debris (e.g., as measured by optical sensors) within the cleaning bin 122 of the robot 100 and/or the canister 204 of the docking station 200. In the presence of the maintenance condition 164X, it may be recommended that the user of the robot 100 check the evacuation port 164 for damage, clear any existing blockages, and/or replace the access mechanism.

A sixth maintenance condition 142X can correspond to a condition affecting the drive wheel 142a. For illustrative purposes, the maintenance condition 142X is depicted in FIG. 4 as affecting only the drive wheel 142a. However, it could additionally or alternatively affect the other drive wheel 142b. In some implementations, the maintenance condition 142X can correspond to presence of hair (e.g., human hair, pet hair, etc.) or another object tangled around the drive wheel 142a. In some implementations, the maintenance condition 142X can correspond to damage incurred by the drive wheel 142a. The maintenance condition 142X can be visually detectable, for example, by visually identifying a foreign object wrapped around the drive wheel 142a or by visually identifying signs of damage to drive wheel 142a. The maintenance condition can also be detectable, for example, by detecting abnormal behavior with respect to the drive wheel 142a such as an abnormally high current draw when rotating the drive wheel 142a. In the presence of the maintenance condition 142X, it may be recommended that the user of the robot 100 dislodge any objects tangled around the drive wheel 142a and/or replace the drive wheel 142a. Depending on the orientation of the drive wheel 142a, signs of damage to the drive wheel 142a and/or foreign objects stuck to the drive wheel 142a may not always be immediately visible from the underside of the robot 100. Thus, in some examples, the drive wheel 142a of the robot 100 can be rotated to assist with visually detecting the maintenance condition 142X.

A seventh maintenance condition 140X can correspond to a condition affecting the side brush 140. In some implementations, the maintenance condition 140X can correspond to the presence of hair (e.g., human hair, pet hair, etc.) or another object tangled around the side brush 140. The foreign can be tangled around a hub of the side brush 140 and/or around one or more arms of the side brush 140. In some implementations, the maintenance condition 144X can correspond to damage incurred by the side brush 140 such as missing or damaged arms. The maintenance condition 140X can be visually detectable, for example, by visually identifying a foreign object wrapped around the side brush 140 or by visually identifying signs of damage to the side brush 140 (e.g., wear and tear of the side brush bristles, damage to a side brush arm, etc.). In the presence of the maintenance condition 140X, it may be recommended that the user of the robot 100 dislodge any objects tangled around the side brush 140 and/or replace the side brush 140.

Other maintenance conditions can correspond to the satisfaction of one or more qualifying criteria indicating that user maintenance may be recommended (e.g., to encourage a user to adhere to a recommended maintenance schedule). For example, the qualifying criteria may include a threshold for an amount of time since user maintenance was last performed, a threshold for a number of docking events since user maintenance was last performed, a threshold for a number of evacuation operations executed since user maintenance was last performed, a threshold number of cleaning operations executed since user maintenance was last performed, etc. Thus, although not visually detectable, a maintenance condition can still be determined to exist if one or more of these thresholds are exceeded.

In general, detecting maintenance conditions and alerting a user about them as early as possible can be advantageous for maximizing the performance and lifespan of cleaning systems (e.g., cleaning system 10). The technology described herein includes systems, methods, and apparatuses for automatically detecting maintenance conditions such as the ones described above and for alerting the user to the detected maintenance conditions.

Cleaning systems that include a mobile robot and a docking station can be particularly useful for implementing automatic detection of maintenance conditions and for alerting a user to the detected maintenance conditions. Referring to FIG. 5, the cleaning system 10 is depicted with the robot 100 docked at the docking station 200. In FIG. 5, components shown in dotted lines are depicted schematically. The robot 100 is on the platform 206 and is properly positioned such that the electrical contacts 162 of the robot 100 are aligned with the electrical contacts 245 of the docking station 200 and such that the evacuation port 164 of the robot 100 is aligned with the intake port 227 of the docking station 200. As previously described, when the robot 100 is properly docked, the cleaning system 10 can perform charging operations to charge the robot 100. The cleaning system 10 can also perform evacuation operations to move debris from the cleaning bin 122 of the robot 100 through the evacuation port 164, through the intake port 227, along the flow path 230 (shown in FIG. 3A), and into the canister 204, where it is stored in the bag 235 (shown in FIG. 3A).

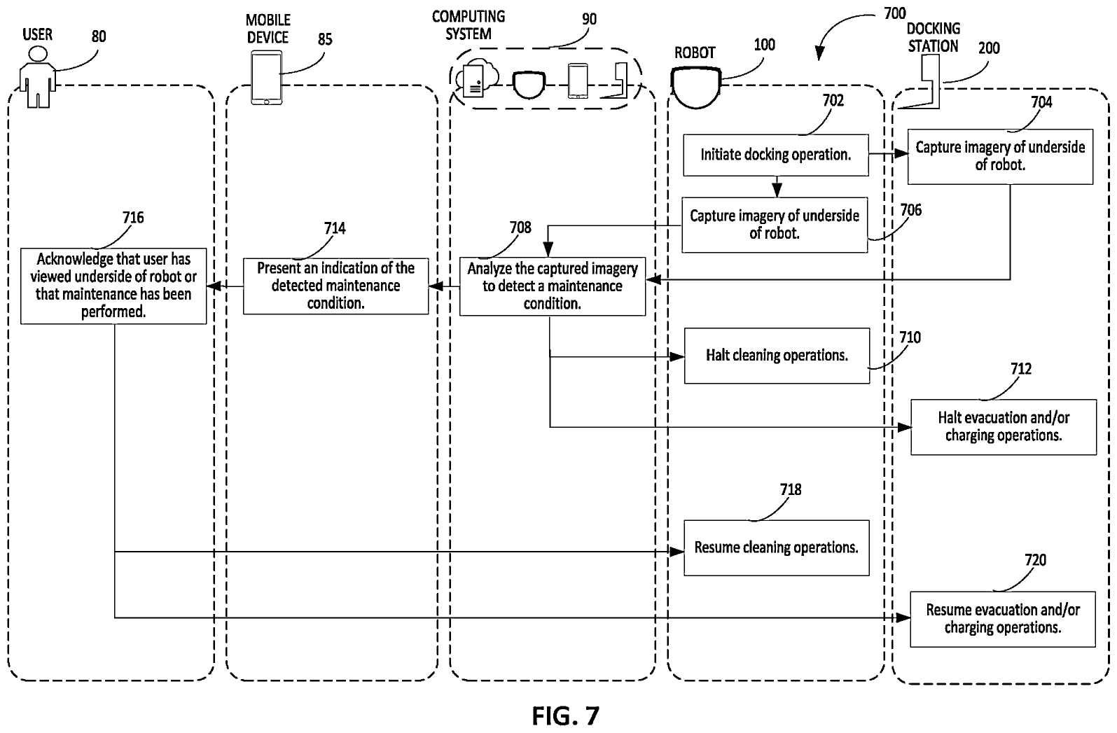

The cleaning system 10 can also be used to detect maintenance conditions such as the ones described above. In some implementations, the cleaning system 10 can utilize the image capture device 250 of the docking station 200 to detect the presence of visually detectable maintenance conditions (e.g., maintenance conditions 144X, 162X, 152X, 110X, 164X, 142X, 140X). After the robot 100 is properly docked, the image capture device 250 can be used to capture imagery of the underside of the robot 100. The image capture device 250 can also be used to capture imagery of the robot 100 as the robot 100 navigates toward the docking station 200, as the robot 100 drives onto the platform 206, and/or as the robot 100 drives off of the platform 206. In some implementations, multiple images can be captured by the image capture device 250 while the robot 100 idles the brush motor 118 to rotate the rollers 110, 112 in order to detect otherwise hidden maintenance conditions. The captured imagery can be analyzed (e.g., by the controller 213 of the docking station 200 or by a remote computing system or by the computing system 90 shown in FIG. 7) to detect the presence of one or more maintenance conditions. For example, images captured by the image capture device 250 can be input to an image analysis pipeline or to a trained machine learning model (e.g., a convolutional neural network model) to identify any visually detectable maintenance conditions (e.g., hair wrapped around a robot component, excessive debris on a robot component, a damaged robot component, etc.).

In some implementations, the image capture device 160 of the robot 100 can be used, instead of or in addition to, the image capture device 250 disposed on the docking station 200 to detect the presence of visually detectable maintenance conditions (e.g., maintenance conditions 144X, 162X, 152X, 110X, 164X, 142X, 140X). For example, the docking station 200 can include one or more optical components 295 such as mirrors or lenses that are configured to alter the field of view of the image capture device 160 to enable capturing imagery of the underside of the robot 100 when the robot 100 is properly docked at the docking station 200 or when the robot 100 is approaching or backing away from the docking station 200. The optical components 295 can be disposed on an external surface of the docking station 200 and/or internal to the housing 202. In some implementations one or more light sources in addition to the light source 255 can be included in the docking station 200 to enhance the quality of the captured imagery. The image capture device 160 can also be used to capture imagery of the robot 100 as the robot 100 navigates toward the docking station 200 and/or as the robot 100 drives onto the platform 206. In some implementations, multiple images can be captured by the image capture device 160 while the robot 100 idles the brush motor 118 to rotate the rollers 110, 112 in order to detect otherwise hidden maintenance conditions. The captured imagery can be analyzed (e.g., by the controller 213 of the docking station 200, by the robot controller circuit 146, by a remote computing system, or by the computing system 90 shown in FIG. 7) to detect the presence of one or more maintenance conditions. For example, images captured by the image capture device 160 can be input to an image analysis pipeline or to a trained machine learning model (e.g., a convolutional neural network model) to identify any visually detectable maintenance conditions (e.g., hair wrapped around a robot component, excessive debris on a robot component, a damaged robot component, etc.).

The cleaning system 10 can also detect maintenance conditions using non-visual techniques. For example, the controller 213 of the docking station 200, the robot controller circuit 146, and/or a remote server can analyze the performance of the cleaning system 10 to detect a maintenance condition. In some implementations, the maintenance condition 162X (affecting one of the electrical contacts 162) can be detected by identifying an unexpected absence of communication between the robot 100 and the docking station 200 despite the robot 100 being docked at the docking station 200. The maintenance condition 152X (affecting the cliff sensor 152) can be detected by identifying frequent false positive detection of potential cliffs. The maintenance condition 110X (affecting the roller 110) can be detected by identifying an abnormally high current draw when rotating the roller 110. The maintenance condition 142X (affecting the drive wheel 142a) can be detected by identifying an abnormally high current draw when rotating the drive wheel 142a. In some implementations, the maintenance condition 164X (affecting the evacuation port 164) can be detected by identifying an absence of change in the levels of debris within the cleaning bin 122 of the robot 100 and/or the canister 204 of the docking station 200. The maintenance condition 164X can also be detected by identifying unexpected air flow rates or air pressure values (e.g., as measured by air pressure sensor 228 shown in FIG. 3A). Air pressure values measured by the air pressure sensor 228 can also be indicative of a maintenance condition affecting the filter 130 such as a build-up of debris. In the presence of such a maintenance condition, it may be recommended that the user of the robot 100 clean and/or replace the filter 130.

Still other maintenance conditions can be detected by the cleaning system 10, for example, by tracking a number of docking events, a number of evacuation operations, or an amount of time since user maintenance was last performed. Tracking such metrics can be performed by the robot 100, the docking station 200, and/or by a remote computing device (e.g., computing system 90 shown in FIG. 7).

Upon detecting a maintenance condition, an alert can be sent to a mobile computing device 85 (shown in FIG. 7) associated with a user 80 to make the user 80 aware of the maintenance condition. The alert can be sent to the mobile computing device 85 by the computing system 90, which can include one or more computing resources of the robot 100, the docking station 200, and/or a remote computing device.

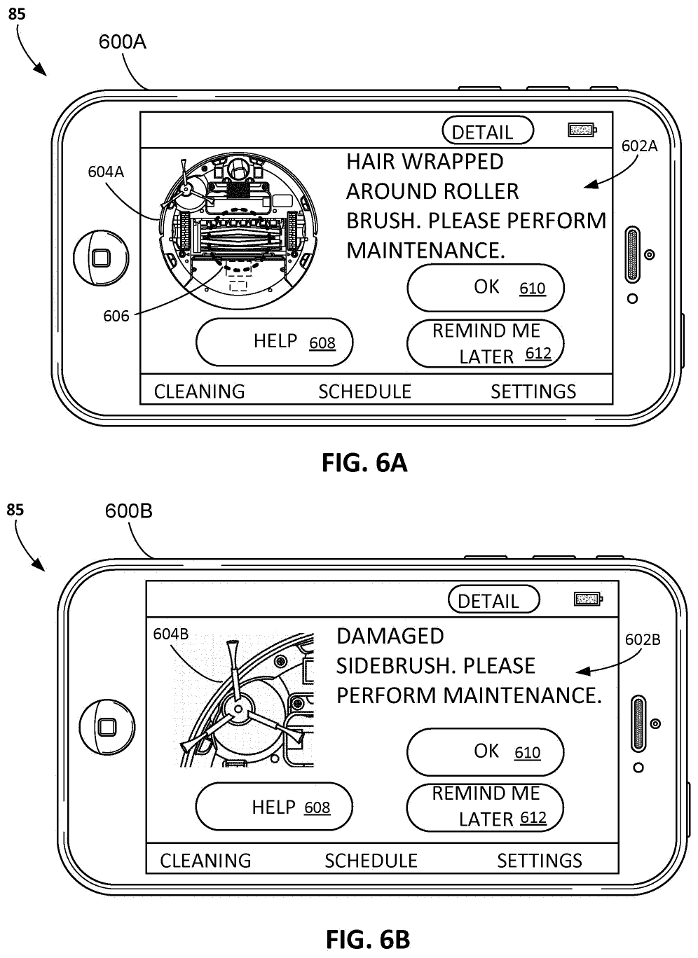

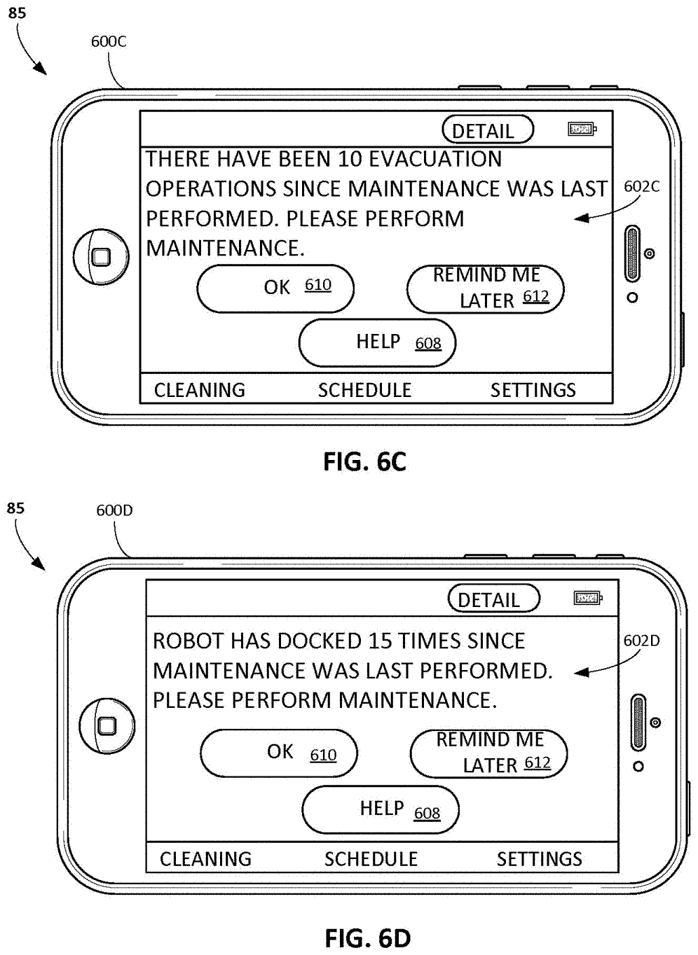

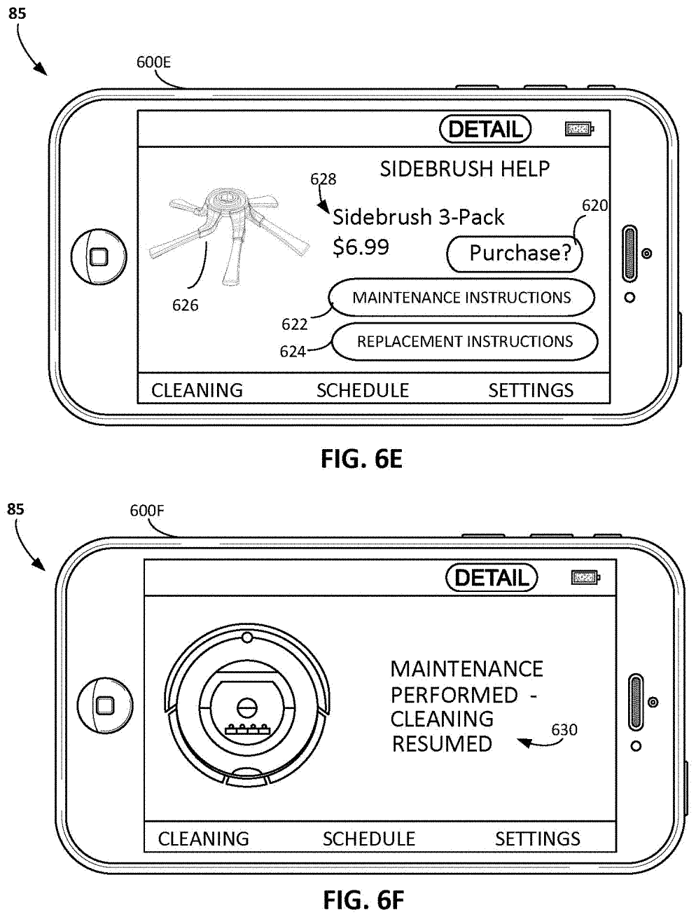

FIGS. 6A-6F are diagrams illustrating exemplary user interface displays presented on the mobile computing device 85 and illustrate an example user interface (UI) for alerting the user 80 to a maintenance condition and for receiving feedback from the user 80. After a maintenance condition is detected, a push notification can be sent to the mobile computing device 85 (sometimes referred to simply as a “mobile device”) including a message stating that a maintenance condition has been detected. The user 80 can interact with the push notification and/or open an application on the mobile device 85 to view more details. While visual and textual alerts are described in detail herein, in some implementations, the mobile computing device 85 can alert the user with an audible or tactile (e.g., a vibrational) alert.

Referring to FIG. 6A, the user 80 can navigate to a UI display 600A presented on the mobile computing device 85. The display 600A can include details about the detected maintenance condition including a text description 602A and a graphic component 604A. In the example shown in FIG. 6A, the text description 602A includes a message describing that the maintenance condition corresponds to hair wrapped around a roller brush of the user's robot and a request for the user 80 to perform maintenance. The graphic component 604A can be an image or icon representing the full underside of the robot 100 and can include a visual indicator 606 highlighting a location of the detected maintenance condition. In some implementations, the visual indicator can be circled, have a different color, and/or otherwise be highlighted to draw the attention of the user 80 to a particular region of the graphic component 604A. In some implementations, the cleaning system 10 may halt one or more operations until the user has provided feedback about the maintenance condition. For example, the docking station 200 may halt charging operations and/or evacuation operations, and the robot 100 may halt cleaning operations until the user has provided feedback about the maintenance condition.

The display 600A can include user-selectable affordances 608, 610, 612 to receive feedback from the user 80. For example, the user 80 can select affordance 608 to indicate that he would like further help. For example, the user 80 may select affordance 608 if the user 80 does not understand the text description 602A and/or the graphic component 604A. Alternatively, the user 80 may select affordance 608 if the user 80 is uncertain about how to properly address the detected maintenance condition. In some implementations, the user's selection of affordance 608 can cause another UI display 600E (described below in relation to FIG. 6F) to be presented on the mobile device 85.

The user 80 can select affordance 610 to indicate that she has seen the alert, examined the robot 100, and/or performed maintenance to address the maintenance condition. In some implementations, the user's selection of affordance 610 can cause another UI display 600F (described below in relation to FIG. 6F) to be presented on the mobile device 85 and/or can cause the cleaning system 10 to resume any halted operations.

The user 80 can select affordance 612 to indicate that the he has seen the alert, but would like to be reminded about the maintenance condition at a later point in time (e.g., after 1 hour, after 3 hours, after 24 hours, after the next cleaning operation, after the next evacuation operation, after the next docking event, etc.). In some implementations, the user's selection of affordance 612 can cause the cleaning system 10 to temporarily resume any halted operations and remind the user 80 about the maintenance condition after a period of time.

FIG. 6B shows another exemplary UI display 600B for alerting the user 80 about a detected maintenance condition. In this example, a text description 602B includes a message describing that the maintenance condition corresponds to a damaged side brush (e.g., side brush 140 of the robot 100) and a request for the user 80 to perform maintenance. The graphic component 604B can be an image captured of the side brush (e.g., by the image capture device 250 or by the image capture device 160). Compared to the graphic component 604A from UI display 600A, in this implementation, the graphic component 604B does not represent the full footprint of the robot 100, but only includes imagery of a portion of the robot 100.

FIG. 6C shows another exemplary UI display 600C for alerting the user 80 about a detected maintenance condition. In this example, a text description 602C includes a message describing that the maintenance condition corresponds to ten evacuation operations being executed since maintenance was last performed. The text description 602C also includes a request that the user 80 perform maintenance. In this example, the display 600C does not include a graphic component because the maintenance condition is not a visually detectable maintenance condition. However, in other implementations, one or more graphic components such as a generic maintenance condition icon can be displayed.

FIG. 6D shows another exemplary UI display 600D for alerting the user 80 about a detected maintenance condition. In this example, a text description 602D includes a message describing that the maintenance condition corresponds to the robot 100 docking to the docking station 200 fifteen times since maintenance was last performed. The text description 602D also includes a request that the user 80 perform maintenance. In this example, the display 600D does not include a graphic component because the maintenance condition is not a visually detectable maintenance condition. However, in other implementations, one or more graphic components such as a generic maintenance condition icon can be displayed.

FIG. 6E shows an exemplary UI display 600E for providing maintenance help to the user. In some examples, the display 600E can be presented on the mobile device 85 in response to the user selecting affordance 608 on any of the displays 600A-600D. In this example, the maintenance condition corresponds to a damaged side brush 140 of the robot 100. The display 600E can include an affordance 622, which can be selected by the user 80 to review further information about the detected maintenance condition, how to address it, and how to prevent similar damage to the side brush 140 in the future. The display 600E can also include an affordance 624, which can be selected by the user 80 to review step-by-step instructions about how to replace the damaged side brush 140. In some implementations, the display 600E can include an affordance 620, which the user can select to purchase one or more replacement components. The name and price 628 of one or more recommended replacement components can be presented on the display 600E as well as an image 626 corresponding to the recommended replacement components.

FIG. 6F shows an exemplary UI display 600F confirming that maintenance has been performed and that one or more halted operations of the cleanings system 10 have resumed. In some examples, the display 600F can be presented on the mobile device 85 in response to the user selecting affordance 610 or affordance 612 on any of the displays 600A-600D. In this example, the display 600F includes a message 630 indicating that the robot 100 has resumed a cleaning operation. In other implementations, similar messages can be presented on the display 600F to indicate that a charging operation and/or evacuation operation of the docking station 200 have been resumed. In some implementations the message may not state that the halted operations have immediately been resumed, but may simply state that the halted operations are ready to be resumed.

FIG. 7 illustrates a process 700 for alerting the user 80 to perform maintenance on the mobile cleaning robot 100. The process 700 includes operations 702, 704, 706, 708, 710, 712, 714, 716, 718, 720.

At the operation 702, the robot 100 initiates a docking operation. For example, the robot 100 may initiate the docking operation in response to completing a cleaning operation or in response to detecting a need to charge its battery 148. At the operation 704, the docking station 200 captures imagery of an underside of the robot 100, for example, using the image capture device 250. As previously described, the imagery can be captured as the robot approaches the docking station 200, as the robot drives onto the platform 206 of the docking station 200, or after docking is complete. Alternatively or in addition to operation 704, at operation 706, the robot 100 can capture imagery of its own underside. For example, the imagery can be captured using the image capture device 160.

At operation 708, the imagery captured by the docking station 200 and/or the robot 100 is analyzed by the computing system 90 to detect a maintenance condition. The computing system 90 can be a controller located on the robot 100 (e.g., the robot controller circuit 146), a controller located on the docking station 200 (e.g., the controller 213), a controller located on the mobile computing device 85, a remote computing system, a distributive computing system that includes processors located on multiple devices (e.g., the robot 100, the docking station 200, the mobile device 85, or a remote computing system), processors on autonomous mobile robots in addition to the robot 100, or a combination of these computing devices. The maintenance conditions that are detected can correspond to the maintenance conditions described in relation to FIG. 4 (e.g., maintenance conditions 144X, 152X, 110X, 164X, 142X, 140X, etc.). The maintenance conditions can be detected by the cleaning system 10 using various techniques described herein in relation to FIG. 5.

The operations 710, 712, 714 involve operations performed in response to detecting a maintenance condition. At operation 710, the robot 100 can halt cleaning operations. At operation 712, the docking station 200 can halt evacuation and/or charging operations. At operation 714, an indication of the detected maintenance condition can be presented on the mobile device 85. For example, the indication of the detected maintenance condition can be presented on a UI display corresponding to displays 600A-600D described in relation to FIGS. 6A-6D.

At operation 716, the user 80 can acknowledge that he or she has viewed an underside of the robot 100 and/or that maintenance has been performed. For example, the user's acknowledgement can be indicated by selection of the affordance 610 presented on the UI displays 600A-600D. Alternatively, the user 80 can interact with the mobile device 85 to receive further help regarding the maintenance condition and/or request a future reminder about the maintenance condition.

The operations 718, 720 involve operations performed in response to receiving acknowledgement from the user that he or she has viewed an underside of the robot 100 and/or that maintenance has been performed. At operation 718, the robot 100 resumes cleaning operations and at operation 720, the docking station 200 resumes evacuation and/or charging operations.

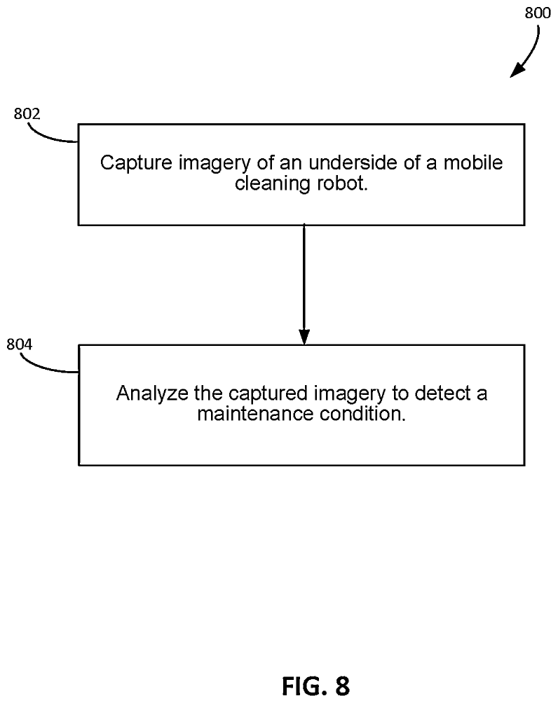

FIG. 8 illustrates an example process 800 for detecting a maintenance condition of a mobile cleaning robot. In some implementations, at least a portion of the process 800 can be performed by a cleaning system (e.g., cleaning system 10), a docking station (e.g., the docking station 200), and/or a mobile cleaning robot (e.g., the robot 100).

Operations of the process 800 can include capturing imagery of an underside of a mobile cleaning robot (802). In some implementations, the mobile cleaning robot can correspond to the robot 100. In some implementations, the imagery can be captured by an image capture device disposed on the robot 100 (e.g., image capture device 160) and/or by an image capture device disposed on a docking station (e.g., image capture device 250). In some implementations, the imagery can be captured while the robot is in a docking position or while the robot navigates onto a platform (e.g., platform 206) of a robot docking station. In some implementations, a first image of the robot can be captured while the robot 100 is positioned at a first location on the platform and second image can be captured while the robot 100 is positioned at a second location on the platform. In some implementations, the second location may correspond to a docking position of the robot 100.

Operations of the process 800 also include analyzing the captured imagery to detect a maintenance condition (804). In some implementations, the detected maintenance condition can correspond to the maintenance conditions 144X, 152X, 110X, 164X, 142X, 140X. For example, the captured imagery can be analyzed to detect at least one of debris disposed on a charging contact of the mobile cleaning robot, an object wrapped around a roller brush of the mobile cleaning robot, a damaged roller brush of the mobile cleaning robot, a damaged side brush of the mobile cleaning robot, an object wrapped around a side brush of the mobile cleaning robot, an object wrapped around a wheel of the mobile cleaning robot, or debris obstructing an evacuation opening of the mobile cleaning robot.

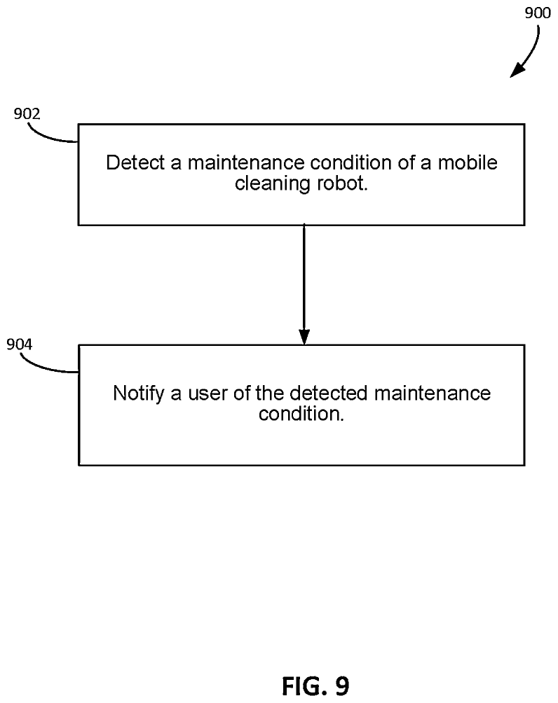

FIG. 9 illustrates an example process 900 for notifying a user of a maintenance condition of a mobile cleaning robot 100. In some implementations, at least a portion of the process 900 can be performed by one or more of a cleaning system (e.g., cleaning system 10), a docking station (e.g., the docking station 200), and a mobile cleaning robot (e.g., the robot 100).

Operations of the process 900 include detecting a maintenance condition of a mobile cleaning robot (902). In some implementations, detecting the maintenance condition of the mobile cleaning robot can include the operations of the process 800. However, in some implementations, where a maintenance condition is not visually detectable, detecting the maintenance condition can include other operations. For example, detecting the maintenance condition can include determining that a predetermined number of docking events have occurred subsequent to a previously detected maintenance condition, determining that a predetermined number of evacuation operations have occurred subsequent to a previously detected maintenance condition, and/or determining that a battery of the mobile cleaning robot is near an end-of-life condition.

Operations of the process 900 also include notifying a user of the detected maintenance condition (904). In some implementations, notifying the user can include transmitting, to a remote computing device, data representative of a maintenance alert corresponding to the detected maintenance condition. For example, the remote computing device can be a mobile device 85 owned by the user 80. In some implementations, notifying the user can include presenting an indication of the detected maintenance condition on a display of the mobile device (e.g., displays 600A-600D).

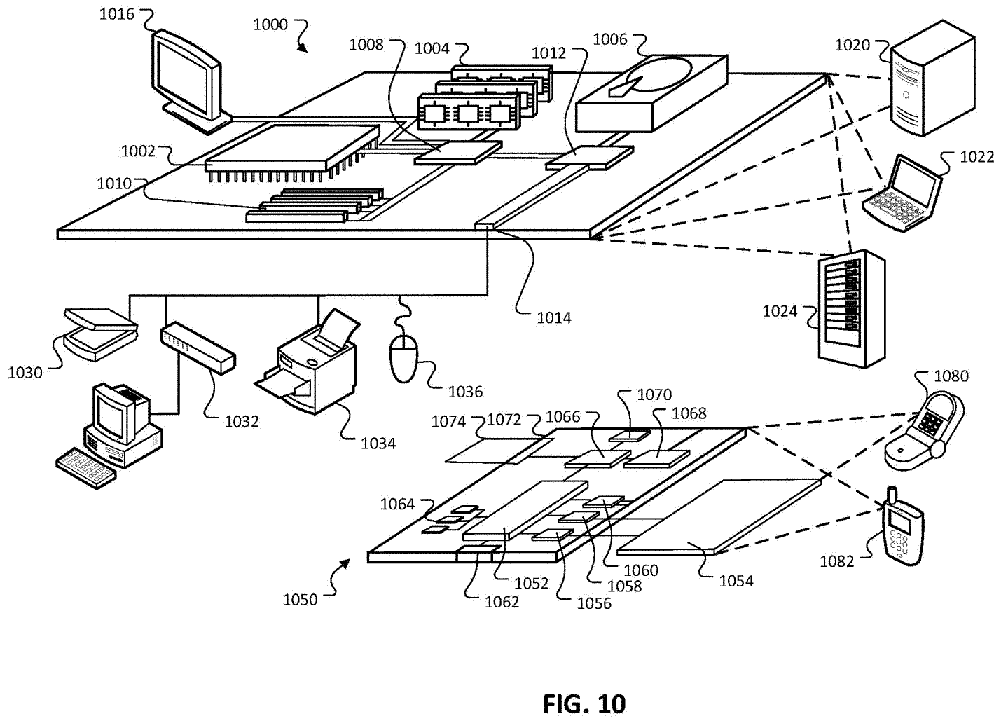

FIG. 10 shows an example of a computing device 1000 and a mobile computing device 1050 that can be used to implement the techniques described here. For example, the computing device 1000 and the mobile computing device 1050 can represent an example of the mobile device 85 and elements of the computing system 90. The computing device 1000 is intended to represent various forms of digital computers, such as laptops, desktops, workstations, personal digital assistants, servers, blade servers, mainframes, and other appropriate computers. The mobile computing device 1050 is intended to represent various forms of mobile devices, such as personal digital assistants, cellular telephones, smart-phones, and other similar computing devices. Additionally, computing device 1000 or 1050 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be examples only, and are not meant to be limiting.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1004 stores information within the computing device 1000. In some implementations, the memory 1004 is a volatile memory unit or units. In some implementations, the memory 1004 is a non-volatile memory unit or units. The memory 1004 may also be another form of computer-readable medium, such as a magnetic or optical disk.

The storage device 1006 is capable of providing mass storage for the computing device 1000. In some implementations, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1002), perform one or more methods, such as those described above. The instructions can also be stored by one or more storage devices such as computer- or machine-readable mediums (for example, the memory 1004, the storage device 1006, or memory on the processor 1002).

The high-speed interface 1008 manages bandwidth-intensive operations for the computing device 1000, while the low-speed interface 1012 manages lower bandwidth-intensive operations. Such allocation of functions is an example only. In some implementations, the high-speed interface 1008 is coupled to the memory 1004, the display 1016 (e.g., through a graphics processor or accelerator), and to the high-speed expansion ports 1010, which may accept various expansion cards. In the implementation, the low-speed interface 1012 is coupled to the storage device 1006 and the low-speed expansion port 1014. The low-speed expansion port 1014, which may include various communication ports (e.g., USB, Bluetooth, Ethernet, wireless Ethernet) may be coupled to one or more input/output devices. Such input/output devices may include a scanner 1030, a printing device 1034, or a keyboard or mouse 1036. The input/output devices may also by coupled to the low-speed expansion port 1014 through a network adapter. Such network input/output devices may include, for example, a switch or router 1032.

The computing device 1000 may be implemented in a number of different forms, as shown in FIG. 10. For example, it may be implemented as a standard server 1020, or multiple times in a group of such servers. In addition, it may be implemented in a personal computer such as a laptop computer 1022. It may also be implemented as part of a rack server system 1024. Alternatively, components from the computing device 1000 may be combined with other components in a mobile device, such as a mobile computing device 1050. Each of such devices may contain one or more of the computing device 1000 and the mobile computing device 1050, and an entire system may be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 may also be provided with a storage device, such as a micro-drive or other device, to provide additional storage. Each of the processor 1052, the memory 1064, the display 1054, the communication interface 1066, and the transceiver 1068, are interconnected using various buses, and several of the components may be mounted on a common motherboard or in other manners as appropriate.

The processor 1052 can execute instructions within the mobile computing device 1050, including instructions stored in the memory 1064. The processor 1052 may be implemented as a chip set of chips that include separate and multiple analog and digital processors. For example, the processor 1052 may be a Complex Instruction Set Computers (CISC) processor, a Reduced Instruction Set Computer (RISC) processor, or a Minimal Instruction Set Computer (MISC) processor. The processor 1052 may provide, for example, for coordination of the other components of the mobile computing device 1050, such as control of user interfaces, applications run by the mobile computing device 1050, and wireless communication by the mobile computing device 1050.

The processor 1052 may communicate with a user through a control interface 1058 and a display interface 1056 coupled to the display 1054. The display 1054 may be, for example, a Thin-Film-Transistor Liquid Crystal Display (TFT) display or an Organic Light Emitting Diode (OLED) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may provide communication with the processor 1052, so as to enable near area communication of the mobile computing device 1050 with other devices. The external interface 1062 may provide, for example, for wired communication in some implementations, or for wireless communication in other implementations, and multiple interfaces may also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 may also be provided and connected to the mobile computing device 1050 through an expansion interface 1072, which may include, for example, a Single In-Line Memory Module (SIMM) card interface. The expansion memory 1074 may provide extra storage space for the mobile computing device 1050, or may also store applications or other information for the mobile computing device 1050. Specifically, the expansion memory 1074 may include instructions to carry out or supplement the processes described above, and may include secure information also. Thus, for example, the expansion memory 1074 may be provided as a security module for the mobile computing device 1050, and may be programmed with instructions that permit secure use of the mobile computing device 1050. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices (for example, processor 1052), perform one or more methods, such as those described above. The instructions can also be stored by one or more storage devices, such as one or more computer- or machine-readable mediums (for example, the memory 1064, the expansion memory 1074, or memory on the processor 1052). In some implementations, the instructions can be received in a propagated signal, for example, over the transceiver 1068 or the external interface 1062.

The mobile computing device 1050 may communicate wirelessly through the communication interface 1066, which may include digital signal processing circuitry where necessary. The communication interface 1066 may provide for communications under various modes or protocols, such as Global System for Mobile communications (GSM) voice calls, Short Message Service (SMS), Enhanced Messaging Service (EMS), or Multimedia Messaging Service (MMS) messaging, code division multiple access (CDMA), time division multiple access (TDMA), Personal Digital Cellular (PDC), Wideband Code Division Multiple Access (WCDMA), CDMA2000, or General Packet Radio Service (GPRS), among others. Such communication may occur, for example, through the transceiver 1068 using a radio-frequency. In addition, short-range communication may occur, such as using a Bluetooth, Wi-Fi, or other such transceiver. In addition, a Global Positioning System (GPS) receiver module 1070 may provide additional navigation- and location-related wireless data to the mobile computing device 1050, which may be used as appropriate by applications running on the mobile computing device 1050. In some implementations, the wireless transceiver 109 of the robot 100 can employ any of the wireless transmission techniques provided for by the communication interface 1066 (e.g., to communicate with the mobile device 85).

The mobile computing device 1050 may also communicate audibly using an audio codec 1060, which may receive spoken information from a user and convert it to usable digital information. The audio codec 1060 may likewise generate audible sound for a user, such as through a speaker, e.g., in a handset of the mobile computing device 1050. Such sound may include sound from voice telephone calls, may include recorded sound (e.g., voice messages, music files, etc.) and may also include sound generated by applications operating on the mobile computing device 1050.

The mobile computing device 1050 may be implemented in a number of different forms, as shown in the figure. For example, it may be implemented as a cellular telephone 1080. It may also be implemented as part of a smart-phone, personal digital assistant 1082, or other similar mobile device.

Various implementations of the systems and techniques described here can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor. In some implementations, modules (e.g., an object detection module), functions (e.g., presenting information on a display), and processes executed by the robot 100, the computing system 90, and the mobile device 85 (described in relation to FIG. 5) can execute instructions associated with the computer programs described above.

To provide for interaction with a user, the systems and techniques described here can be implemented on a computer having a display device (e.g., a cathode ray tube (CRT) or liquid crystal display (LCD) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A robot docking station comprising:
a housing;
a platform defined in the housing, the platform configured to receive a mobile cleaning robot in a docking position; and
a camera disposed in the platform, the camera configured to capture imagery of an underside of the mobile cleaning robot.

2. The robot docking station of claim 1, wherein the camera captures the imagery of the underside of the mobile cleaning robot while the mobile cleaning robot is in the docking position.

3. The robot docking station of claim 1, wherein the camera captures the imagery of the underside of the mobile cleaning robot while the mobile cleaning robot navigates onto the platform.

4. The robot docking station of claim 1, wherein the camera captures a first image of the underside of the mobile cleaning robot while the robot is positioned at a first location on the platform.

5. The robot docking station of claim 4, wherein the first image corresponds to a first component on an undercarriage of the mobile cleaning robot.

6. The robot docking station of claim 4, wherein the camera captures a second image of the underside of the mobile cleaning robot while the robot is positioned at a second location on the platform.

7. The robot docking station of claim 6, wherein the first image corresponds to a first component on an undercarriage of the mobile cleaning robot and the second image corresponds to a second component on the undercarriage of the mobile cleaning robot.

8. The robot docking station of claim 1, wherein a field of view of the camera is sufficiently wide to capture imagery of a full width of the mobile cleaning robot.

9. The robot docking station of claim 1, further comprising one or more optical components configured to increase an effective field of view of the camera.

10. The robot docking station of claim 1, further comprising a light source configured to illuminate the underside of the mobile cleaning robot.

11. The robot docking station of claim 1, further comprising an image analysis module configured to analyze the imagery captured by the camera to detect a maintenance condition.

12. The robot docking station of claim 11, wherein the maintenance condition is indicative of at least one of:
debris disposed on a charging contact of the mobile cleaning robot,
an object wrapped around a roller brush of the mobile cleaning robot,
a damaged roller brush of the mobile cleaning robot,
a damaged side brush of the mobile cleaning robot,
an object wrapped around a side brush of the mobile cleaning robot,
an object wrapped around a wheel of the mobile cleaning robot, or
debris obstructing an evacuation opening of the mobile cleaning robot.

13. The robot docking station of claim 1, further comprising a communication module configured to transmit data to a remote computing device, wherein the transmitted data comprises data representative of the imagery captured by the camera.

14. The robot docking station of claim 1, further comprising a communication module configured to transmit data to a remote computing device, wherein the transmitted data comprises data representative of a maintenance alert.

15. The robot docking station of claim 14, wherein the maintenance alert corresponds to:
a maintenance condition that is detectable via analyzing the imagery captured by the camera,
an occurrence of a predetermined number of docking events,
an occurrence of a predetermined number of evacuation operations, or
an end-of-life of a battery of the mobile cleaning robot.

16. The robot docking station of claim 1, further comprising a communication module configured to transmit data to a remote computing device, wherein the communication module is configured to receive, from the remote computing device, data representative of an acknowledgement that a user has viewed the underside of the mobile cleaning robot.

17. The robot docking station of claim 16, wherein the communication module is configured to transmit a signal to the mobile cleaning robot to prevent the mobile cleaning robot from executing a cleaning operation until the data representative of the acknowledgement is received.

18. A robot cleaning system comprising:
a mobile cleaning robot comprising:
a drive operable to move the mobile cleaning robot across a floor surface,
a cleaning assembly configured to clean the floor surface, and
a debris bin; and
a robot docking station comprising:
a housing, and
a platform defined in the housing, the platform configured to receive the mobile cleaning robot in a docking position; and
a camera configured to capture imagery of an underside of the mobile cleaning robot.

19. The robot cleaning system of claim 18, wherein the camera is disposed on or within the mobile cleaning robot.

20. The robot cleaning system of claim 19, wherein the robot docking station comprises one or more optical components configured to adjust a field of view of the camera to include the underside of the mobile cleaning robot.

21. The robot cleaning system of claim 18, wherein the camera is disposed in the platform of the robot docking station.

22. The robot cleaning system of claim 18, wherein the camera captures the imagery of the underside of the mobile cleaning robot while the mobile cleaning robot is in the docking position.

23. The robot cleaning system of claim 18, wherein the camera captures the imagery of the underside of the mobile cleaning robot while the mobile cleaning robot navigates onto the platform.

24. The robot cleaning system of claim 18, wherein the camera captures a first image of the underside of the mobile cleaning robot while the robot is positioned at a first location on the platform.

25. The robot cleaning system of claim 24, wherein the first image corresponds to a first component on an undercarriage of the mobile cleaning robot.

26. The robot cleaning system of claim 24, wherein the camera captures a second image of the underside of the mobile cleaning robot while the robot is positioned at a second location on the platform.

27. The robot cleaning system of claim 26, wherein the first image corresponds to a first component on an undercarriage of the mobile cleaning robot and the second image corresponds to a second component on the undercarriage of the mobile cleaning robot.

28. The robot cleaning system of claim 18, further comprising a communication module configured to transmit data to a remote computing device, wherein the communication module is configured to receive, from the remote computing device, data representative of an acknowledgement that a user has viewed the underside of the mobile cleaning robot.

29. The robot cleaning system of claim 28, wherein the mobile cleaning robot is configured not to execute a cleaning operation until the data representative of the acknowledgement is received.

30. A method performed by a robot docking station, the method comprising:
capturing imagery of an underside of a mobile cleaning robot and
analyzing the captured imagery to detect a maintenance condition.
